(19) United States
(12) Patent Application Publication
(10) Pub. No.: US 2025/0358318 A1
(43) Pub. Date: Nov. 20, 2025

(54) SYSTEMS AND METHODS FOR MACHINE LEARNING ASSISTED AUTHORIZATION POLICY RECOMMENDATIONS

(71) Applicant: CyberArk Software Ltd., Petach-Tikva (IL)

(72) Inventors: Arik Paran, Petach-Tikva (IL); Ilan Tsanany, Petach-Tikva (IL); Shai Zaga, Petach-Tikva (IL)

(73) Assignee: CyberArk Software Ltd., Petach-Tikva (IL)

(21) Appl. No.: 19/090,809

(22) Filed: Mar. 26, 2025

Related U.S. Application Data
(60) Provisional application No. 63/649,489, filed on May 20, 2024.

(51) Int. Cl. H04L 9/40; H04L 41/16

(52) U.S. Cl. CPC H04L 63/20; H04L 41/16

(57) ABSTRACT

Disclosed embodiments relate to developing machine learning authorization policy recommendations. Techniques may include receiving input data for an organization; pre-processing the input data, wherein the pre-processing includes a feedback loop to update the input data by providing feedback to the organization; generating, using a machine learning model, at least one authorization policy recommendation based on the input data, wherein the machine learning model is trained using at least one of: an organizational attribute, an organizational action, an organization policy, or domain information; providing the at least one authorization policy recommendation to the organization; identifying a status of the at least one authorization policy recommendation, wherein the status comprises at least one organizational feedback; and iteratively updating the machine learning model based on the identified status.

### CROSS-REFERENCE TO RELATED APPLICATION

This application claims the benefit of priority of U.S. Provisional Application No. 63/649,489, filed May 20, 2024. The foregoing application is incorporated herein by reference in its entirety.

### BACKGROUND

### Technical Field

The present disclosure relates generally to generating authorization policy recommendations using machine learning.

### Background Information

In modern computing environments, organizations and administrators managing groups of users need to make decisions regarding whether to allow users or entities to run certain files; access data, applications, or resources; and create permissions. Different organizations may have different goals when it comes to managing users. For example, some organizations may prioritize network environment security, while other organizations may prioritize the user experience, or efficiency of the organization.

Some organizations may not understand what action to apply to new files or applications, or how to create permissions when managing users across an organization. Therefore, there is a need for authorization policy recommendations that take into account an organization's specific needs, while addressing security and environmental concerns. While certain organizations may manually define these rules based on current needs, this approach would not address the ever-changing needs of organizations. By using machine learning models and crowdsourcing data across different organizations, the present solutions provide authorization policy recommendations to address security and operational concerns.

### SUMMARY

The disclosed embodiments describe non-transitory computer readable media, systems, and methods for performing operations for developing machine-learning authorization policy recommendations. For example, in some embodiments, a non-transitory computer readable medium may include instructions that, when executed by at least one processor, cause the at least one processor to perform operations for developing machine-learning authorization policy recommendations. The operations may comprise receiving input data for an organization; pre-processing the input data, wherein the pre-processing includes a feedback loop to update the input data by providing feedback to the organization; generating, using a machine learning model, at least one authorization policy recommendation based on the input data, wherein the machine learning model may be trained using at least one of an organizational attribute, an organizational action, an organization policy, or domain information. The operations may also comprise providing the at least one authorization policy recommendation to the organization; identifying a status of the at least one authorization policy recommendation, wherein the status comprises at least one organizational feedback; and iteratively updating the machine learning model based on the identified status.

According to a disclosed embodiment, the at least one authorization policy recommendation may be automatically enforced by applying the at least one authorization policy recommendation to a network environment associated with the organization.

According to a disclosed embodiment, the at least one authorization policy may be automatically enforced if at least one predetermined condition is met.

According to a disclosed embodiment, the identified status may comprise calculation of an acceptance rate of the at least one authorization policy recommendation by the organization.

According to a disclosed embodiment, the operations may further comprise using at least one other machine learning model.

According to a disclosed embodiment, the machine learning model uses a ranking system for the training.

According to a disclosed embodiment, the ranking may further comprise using at least one of a maturity level of the organization, best practices for an organization, or an organizational system configuration.

According to a disclosed embodiment, the machine learning model may use a ranking system.

According to a disclosed embodiment, the machine learning model may implement one of unsupervised learning, semi-supervised learning, active learning, or reinforcement learning techniques.

According to a disclosed embodiment, the pre-processing may further comprise cleaning the input data using predetermined rules.

According to a disclosed embodiment, the preprocessing may further comprise outlier detection of the input data.

According to a disclosed embodiment, the identifying may further comprise accepting, ignoring, or rejecting the at least one authorization policy recommendation via a user interface.

According to a disclosed embodiment, the identifying may further comprise providing feedback on the accepting, ignoring, or rejecting via the user interface.

According to a disclosed embodiment, the identifying may further comprise using the feedback for the machine learning model.

According to a disclosed embodiment, the feedback may be used to mitigate against diversion from best practices.

According to a disclosed embodiment, the identifying may occur in real time.

According to a disclosed embodiment, the identifying may further comprise reinforcing the at least one authorization policy recommendation if the organization accepts the recommendation.

According to a disclosed embodiment, the at least one authorization policy recommendation may comprise a confidence level.

According to a disclosed embodiment, the confidence level may comprise a categorical level and a probabilistic level.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an example system environment for machine learning assisted authorization policy recommendations, consistent with disclosed embodiments.

FIG. 2A is an example recommendation system environment, consistent with disclosed embodiments.

FIG. 2B is an exemplary embodiment of an example machine learning engine environment, consistent with disclosed embodiments.

FIG. 3 illustrates a block diagram of an example server, consistent with disclosed embodiments.

FIG. 4 is a schematic diagram of a distributed system for implementing the disclosed embodiments, consistent with disclosed embodiments.

FIG. 5 is a flowchart showing an example process for machine learning assisted authorization policy recommendations, consistent with disclosed embodiments.

FIG. 6 is an exemplary diagram of a user interface, consistent with disclosed embodiments.

FIG. 7 is an exemplary diagram of a feedback loop, consistent with disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

The techniques for authentication described herein overcome several technological problems relating to security, efficiency, and functionality in the fields of cybersecurity and secure access to data, code, or applications.

Reference will now be made in detail to the disclosed embodiments, examples of which are illustrated in the accompanying drawings.

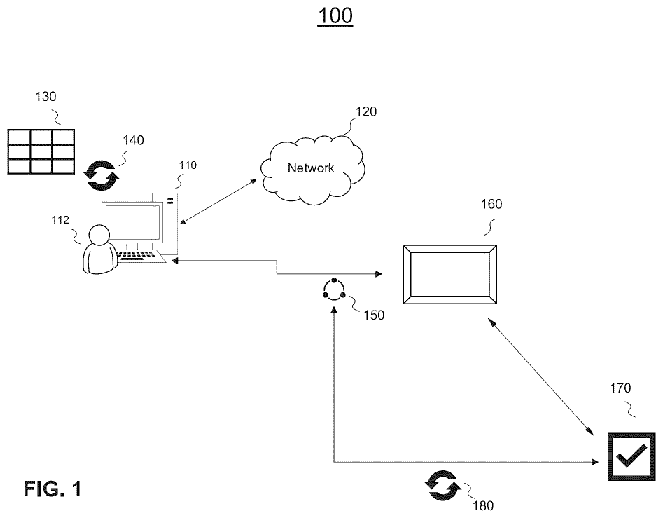

FIG. 1 illustrates an example system environment 100 for machine learning assisted authorization policy recommendations. The various components of system 100 may communicate over a network 120. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 100 is shown as a network-based environment, it is understood that in some embodiments, one or more aspects of the disclosed systems and methods may also be used in a localized system, with one or more of the components communicating directly with each other.

System 100 may also include computing components 110. Computing components 110 may include or be part of a computing device and may include a user interface, computer data storage, a browser engine, a rendering engine, a secure web browser, a data persistence layer, and any other components necessary to run a web browser. In some embodiments, computer data storage may comprise computer components and recording media that are used to retain digital data. Data may be stored in memory, on servers, or in cloud computing environments. Computer data storage may be managed using a central processing unit of a computer. The browser engine may receive input from a user interface and process it to command a rendering engine. This browser engine may be used to provide an interactive user experience. For example, when a user clicks or selects an element on a user interface, the browser engine may ensure that the browser redirects to the clickable element. In some embodiments, the browser engine is an intermediary between the user interface and a rendering engine. The rendering engine may be a component responsible for rendering web content, such as HTML, CSS, or JavaScript, etc., into a visual display on a user interface.

System 100 may also include an organization 112. An application, user, or administrator may interact with system 100 on behalf of organization 112. Organization 112 may interact with system 100 using computing components 110. Computing components 110 may receive input data 130 for an organization, such as organization 112. System 100 may also include a pre-processing mechanism 140 to process input data 130. In some embodiments, pre-processing mechanism 140 may include removal of personally identifiable information, data obfuscation, data filtering, or content rating. In some embodiments, data obfuscation may be a process that modifies sensitive data to make it difficult for unauthorized users to access or understand the data. For example, data obfuscation may mask access to sensitive information such as passwords, or to personally identifiable information such as social security numbers. In some embodiments, data filtering may be a process of selecting and displaying specific parts of a dataset based on predetermined criteria. In some embodiments, content rating may refer to categorizing data based on different content categories.

System 100 may also include a machine learning model 150. In some embodiments, machine learning model 150 may be an unsupervised learning model (as described herein), a collaborative filtering model, a reinforcement learning model (as described herein), a behavioral analytic model, a profiling and segmenting model, or a personalization model. In some embodiments, a collaborative filtering model may refer to a system that suggests items to users based on how users with similar preferences have interacted with the items. In some embodiments, a behavioral analytic model may use behavior analysis to understand how behavior is learned and changes over time. In some embodiments, a profiling and segmenting model may gather and analyze data to develop profiles and segregate the profiles into specific groups. In some embodiments, a personalization model may target a specific individual or group based on performance metrics and constraints. System 100 may include more than one machine learning model.

System 100 may also include authorization policy recommendation 160. In some embodiments, authorization policy recommendation 160 may be a tailored security recommendation for an organization or user. In some embodiments, authorization policy recommendation 160 may provide details about how to apply the recommendation within a specific application and how to optimize the recommendation. In some embodiments, authorization policy recommendation 160 may include an auditing recommendation, targeting options, or further policy recommendations. In some embodiments, authorization policy recommendation 160 may also be re-evaluated over time. In some embodiments, authorization policy recommendation 160 may be updated based on an update to input data 130. System 100 may also include status 170. In some embodiments, status 170 may show whether a user or organization has accepted, rejected, modified, or ignored a recommendation, such as authorization policy recommendation 160. System 100 may also include a mechanism 180 to iteratively update the machine learning model 150. In some embodiments, an iterative update may occur on a predetermined basis. In some embodiments, an iterative update may occur based on a triggering event. In other embodiments, an iterative update may occur based on a user request.

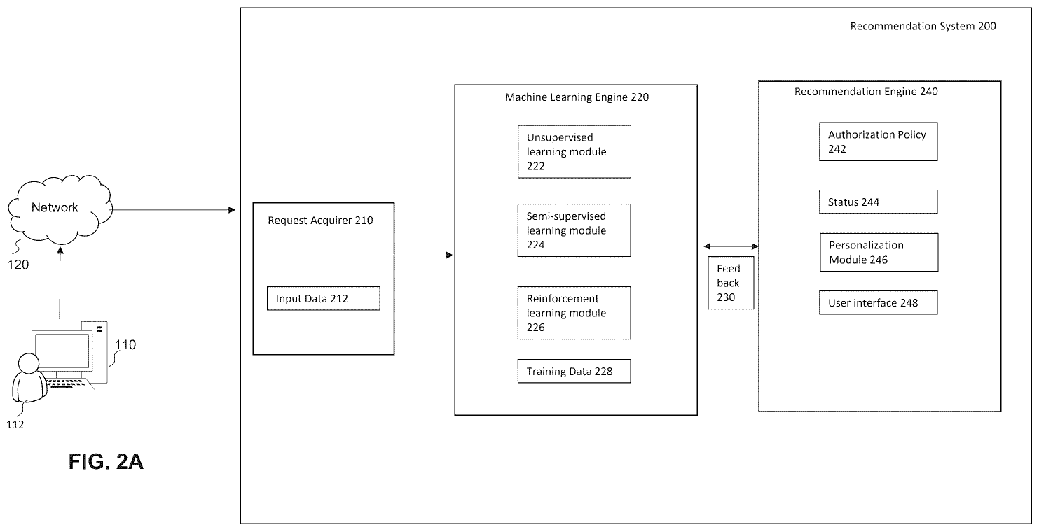

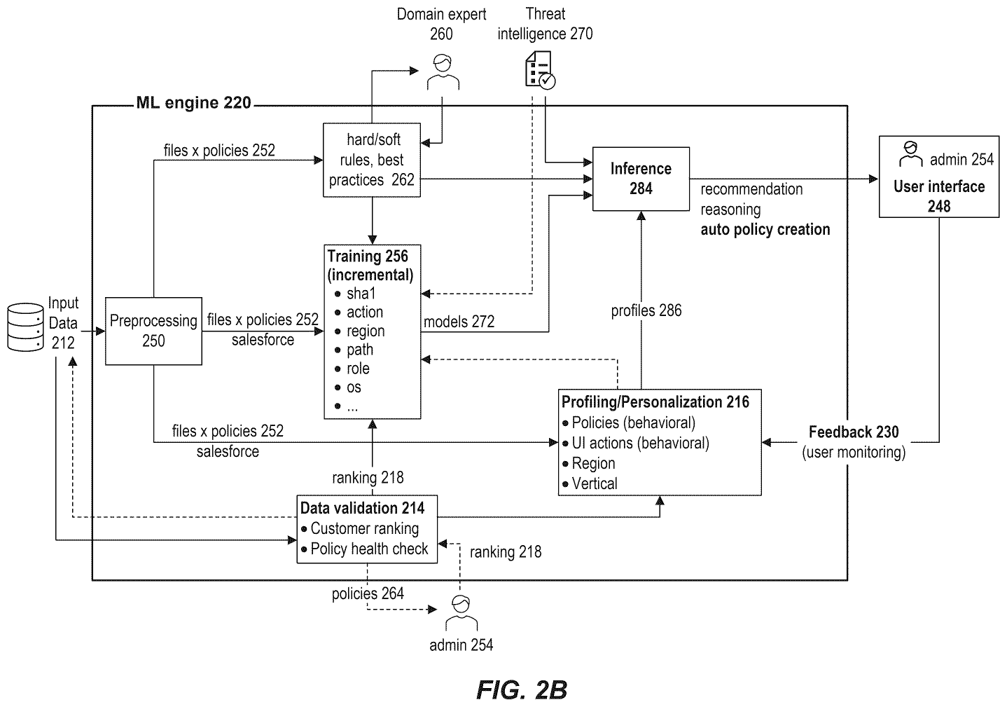

FIG. 2A is an example recommendation system environment, consistent with disclosed embodiments. As illustrated, recommendation system 200 may comprise organization 112, computing components 110, network 120, request acquirer 210, input data 212, machine learning engine 220, unsupervised learning module 222, semi-supervised learning module 224, reinforcement learning module 226, training data 228, feedback 230, recommendation engine 240, authorization policy 242, status 244, personalization module 246, and user interface 248.

The machine-learning aspects described herein (e.g., machine learning engine 220, unsupervised learning module 222, semi-supervised learning module 224, reinforcement learning module 226, training data 228, feedback 230, and recommendation engine 240, etc.) may be deployed in several ways. For example, machine learning algorithms (also referred to as artificial intelligence) may be employed for the purposes of developing machine-learning authorization policy recommendations. Such algorithms may be trained using training examples, as described below. Some non-limiting examples of such machine learning algorithms may include classification algorithms, data regressions algorithms, segmentation algorithms, visual detection algorithms, visual or textual recognition algorithms, speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs (e.g., input data, as described herein) together with the desired outputs (e.g., security rules or policies) corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes, and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper-parameters, where the hyper-parameters may be set manually by a person or automatically by a process external to the machine learning algorithm (such as a hyper-parameter search algorithm), and the parameters of the machine learning algorithm may be set by the machine learning algorithm according to the training examples. In some embodiments, the hyper-parameters may include a region, a market, an industry, a business size, or a security maturity. It is to be understood that these are merely exemplary and not limited in nature. In some implementations, the hyper-parameters may be set according to the training examples and the validation examples, and the parameters may be set according to the training examples and the selected hyper-parameters.

In some embodiments, training may occur on an incremental, periodic, or continuous basis. Training may occur, for example, based on policy information related to previous actions associated with an organization, a region associated with an organization, a path associated with a particular data set, a role associated with an organization, or an operating system of the organization. In some embodiments, an administrator associated with the organization may perform data validation on input data before it is trained using machine learning algorithms, consistent with disclosed embodiments. In some embodiments, an administrator may be a user with certain privileges to change settings on a computer system associated with the organization. In some embodiments, the data validation may be based on a ranking of an organization or a policy health check. In some embodiments, the ranking of an organization may be based on parameters such as user privileges, organization security maturity, industry, or other indicators. In some embodiments, a policy health check may provide insights into the health of policy implementation. In some embodiments, a policy health check may refer to validating security controls. In some embodiments, a policy health check may refer to confirming the application of security controls. In some embodiments, a policy health check may refer to a review of security configurations within an environment.

In some embodiments, trained machine learning algorithms (e.g., artificial intelligence algorithms) may be used to analyze inputs and generate outputs, for example in the cases described herein. In some examples, a trained machine learning algorithm may be used as an inference model that, when provided with an input, generates an inferred output (e.g., particular classification of a food item). For example, a trained machine learning algorithm may include a classification algorithm, the input may include a sample, and the inferred output may include a classification of the sample (such as an inferred label, an inferred tag, and so forth). In another example, a trained machine learning algorithm may include a regression model, the input may include a sample, and the inferred output may include an inferred value for the sample. In yet another example, a trained machine learning algorithm may include a clustering model, the input may include a sample, and the inferred output may include an assignment of the sample to at least one cluster.

In some embodiments, artificial neural networks may be configured to analyze inputs and generate corresponding outputs. Some non-limiting examples of such artificial neural networks may comprise shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long short-term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

In some embodiments, organization 112 may interact with recommendation system 200 over a network, such as network 120. In some embodiments, network 120 may be in communication with recommendation system 200. Network 120 may communicate directly with request acquirer 210. Request acquirer 210 may acquire a request for a recommendation, consistent with disclosed embodiments. In some embodiments, request acquirer 210 may receive a request from organization 112. In other embodiments, request acquirer 210 may automatically receive a request based on a user request or on a predefined schedule. In some embodiments, upon receiving a request, request acquirer may receive input data 212. In some embodiments, input data 212 may include application details, such as a file name, a publisher, a file path, and any other information related to the application.

Machine learning engine 220 may include unsupervised learning module 222, semi-supervised learning module 224, reinforcement learning module 226, and training data 228. In some embodiments, machine learning engine 220 may be configured to manage different types of machine learning modules, consistent with disclosed embodiments. In some embodiments, unsupervised learning module 222 may use machine learning algorithms to analyze and cluster unlabeled data sets, consistent with disclosed embodiments. For example, Unsupervised learning module 222 may use techniques such as collaborative filtering and recommendations systems to analyze and cluster the unlabeled data sets. In some embodiments, semi-supervised learning module 224 may use machine learning algorithms, such as Bayesian Networks, to analyze and cluster data sets. In some embodiments, semi-supervised learning module 224 may use both supervised and unsupervised learning. In some embodiments, reinforcement learning module 226 may use machine learning to make decisions to achieve optimal or enhanced results. Reinforcement learning module 226 may use reinforcement learning, including active learning techniques, to minimize the number of required labeled data. In some embodiments, reinforcement learning module 226 may use collaborative filtering, clustering, or active learning. In some embodiments, training data 228 may include session data associated with an organization, such as logs of commands, recording of on-screen behavior, interactions with organizational policies, file access, network activity, database queries, application use, executed scripts, historical data associated with an organization, or any other form of data.

Feedback 230 may communicate between machine learning engine 220 and recommendation engine 240. In some embodiments, feedback 230 may refer to information that a user, such as an administrator, provides based on monitoring the overall system. In some embodiments, feedback 230 may be used to improve upon recommendations created by recommendation engine 240. In some embodiments, feedback 230 may include user actions (such as accepting, rejecting, ignoring, or editing a recommendation). In other embodiments, feedback 230 may include a reasoning for the action a user took. In some embodiments, feedback 230 may be in the form of monitoring reports based on an internal analysis from an organization. In some embodiments, feedback 230 may be based on best practices associated with an organization. In some embodiments, feedback 230 may be based on rules associated with an organization. In some embodiments, feedback 230 may be incorporated into the recommendation engine 240 immediately. In other embodiments, feedback 230 may be incorporated into recommendation engine 240 on a periodic basis. In some embodiments, recommendation engine 240 may output an authorization policy, such as authorization 242.

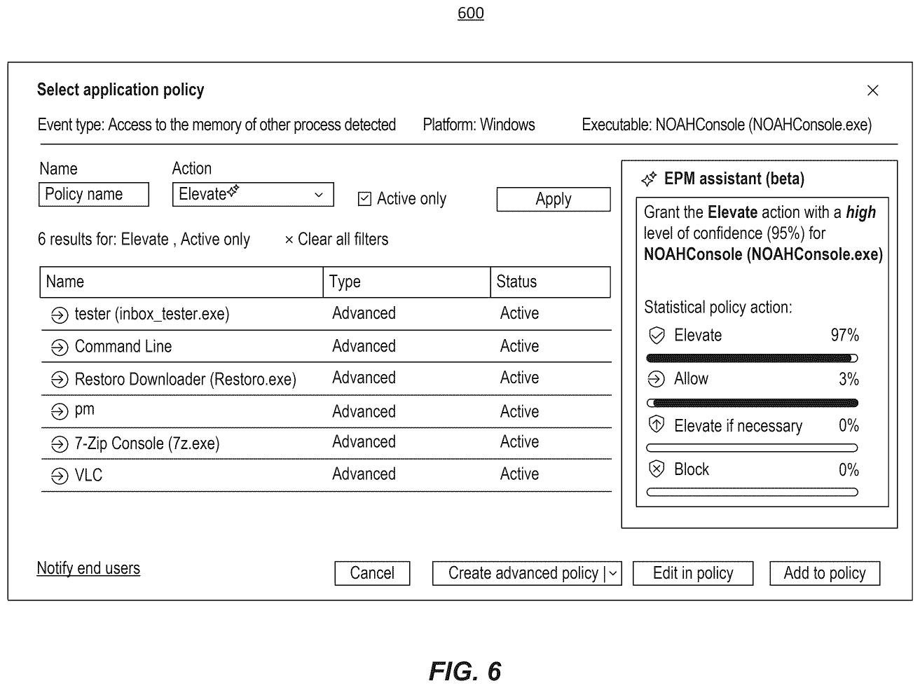

Recommendation engine 240 may include authorization policy 242, status 244, personalization module 246, and user interface 248, as further described with respect to FIG. 6. Personalization module 246 may use organizational specific information, such as geographic region, country, industry, sub-industry, market, sub-market, company size, and other indicators to personalize the authorization policy. In some embodiments, a user may have the ability to select, on a user interface, an authorization policy to apply. In some embodiments, a user may modify the recommended authorization policy. In other embodiments, a user may select an authorization policy to be applied.

FIG. 2B is an embodiment of an example machine learning engine environment, consistent with disclosed embodiments. As illustrated, machine learning engine 220 may be a machine learning engine as described with respect to FIG. 2A. Machine learning engine 220 may include input data 212, as described with respect to FIG. 2A. Machine learning engine 220 may also include preprocessing 250, files and policies 252, system administrator 254, training algorithm 256, data validation 214, customer profiling and personalization 216, ranking 218, domain expert 260, trusted publisher and files 262, policies 264, threat intelligence 270, hard/soft rules, best practices 282, models 272, inferences 284, and profiles 286.

At preprocessing 250, machine learning engine 220 may perform preprocessing of input data 212. In some embodiments, preprocessing 250 may include detecting and correcting corrupt or inaccurate records from a data set, identifying incorrect, incomplete, or irrelevant parts of a data set, and modifying, replacing, or deleting the data. In some embodiments, preprocessing 250 may further include manipulation or filtration of data based on predetermined rules set by an organization. In other embodiments, preprocessing 250 may also include classifying, ranking, and fusing data records. In other embodiments, preprocessing 250 may include validation of duplication and deleting duplicate records.

In some embodiments, after input data 212 is preprocessed, the data may then be organized based on organizational filing and policies at files and policies 252. In some embodiments, input data 212 may be pushed to a trusted publisher and files 262. In some embodiments, a file may be a representation of an application within an organization. In some embodiments, a policy may be the rule that determines how the file is handled. In some embodiments, a trusted publisher and files 262 may refer to an aggregation of files that are developed and digitally signed by a company. In some embodiments, trusted publisher and files 262 may be represented by a certificate signing authority of an application. In some embodiments, a domain expert 260 may use the organization's specified files and policies to create inferences 284 for what recommendations to provide to a user. In some embodiments, domain expert 260 may refer to a user or person with specialized knowledge or skills related to machine learning engine 220. Inferences 284 may generate recommendations based on the modeling. Accordingly, inferences 284 may refer to predictions used to make a recommendation, consistent with disclosed embodiments. In some embodiments, inferences 284 may use information gleaned from models 272. Models 272 may refer to any of the machine learning models discussed with respect to FIG. 2A.

In some embodiments, threat intelligence 270 may refer to an external feed of an analysis of an application risk. In some embodiments, threat intelligence 270 may be incorporated into training machine learning models, consistent with disclosed embodiments. In some embodiments, threat intelligence 270 may be used as part of antivirus risk scores or as part of a risk score engines.

In some embodiments, inferences 284 may use information based on training algorithm 256. Training algorithm 256 may use models 272 to train the input data 212, consistent with disclosed embodiments. In some embodiments, training algorithm 256 may be trained on an incremental basis. In some embodiments, training algorithm 256 may use data including an action related to the input data, a region, a path, a role, or an operating system. In some embodiments, training may occur as described with respect to FIG. 2A. In some embodiments, an action may be the invocation of the application. In some embodiments, the action may be allowed, blocked, elevated, or escalated based on organizational criteria.

In some embodiments, data validation 214 may occur as described with respect to FIG. 2A. In some embodiments, the data validation may be based on a ranking of an organization or a policy health check. In some embodiments, policies 264 may be gleaned from data validation 214 and sent to system administrator 254. An administrator may be an administrator as described with respect FIG. 2A. Ranking 218 may refer to a ranking and selection of system administrators whose associated data will be used to train the model. In some embodiments, system administrator 254 may use the policies 264 to determine a ranking 218 that is then used to further train algorithm 256. For example, training algorithm 256 may generate queries and responses to the queries from system administrator 254 may be used for data labeling.

Profiling and personalization 216 may use organizational-specific information, such as policies, user interface actions, a region, or a vertical to provide data used in inferences 284. In some embodiments, policies may refer to behavioral information based on an organization's historical data. In some embodiments, the results of profiling and personalization 216 may be used in inferences 284 as a set of profiles 286 based on a specific organization. In some embodiments, a vertical may refer to a geographical region, sub-region, country, industry, sub-industry, market, sub-market, company size, or other actions that may be taken for an application.

In some embodiments, hard/soft rules or best practices 282 are also used to determine inferences 284. Hard rules may be, for example, predetermined or permanent, while soft rules may be subject to change (e.g., by users, through machine learning, etc.). In some embodiments, a hard rule may include that certain items cannot be elevated, including but not limited to text editors, command line interfaces, content handlers, or sub-processes.

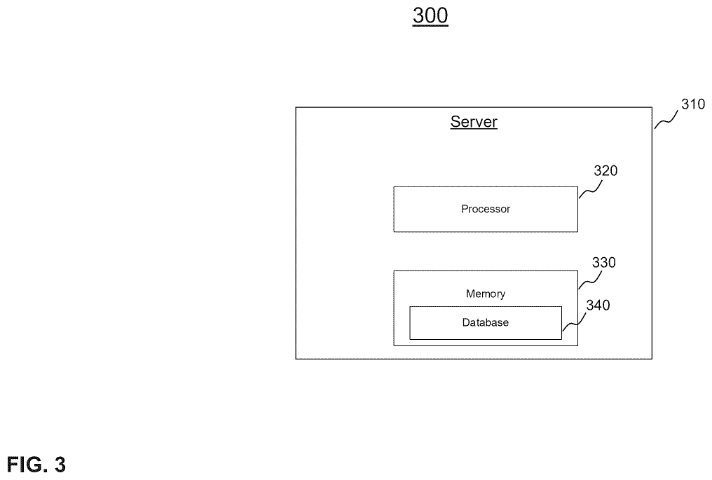

FIG. 3 is a block diagram 300 showing an example server 310, consistent with the disclosed embodiments. Server 310 may be a computing device (e.g., a server, virtual machine, container instance, personal computer, mobile device, IoT device, etc.), and may include one or more associated processors 320 and/or memories 330. Consistent with disclosed embodiments, recommendation system 200 and its components, as illustrated in FIGS. 2A and 2B, may be implemented in accordance with the elements of FIG. 3.

Processor 320 may take the form of, but is not limited to, a microprocessor, embedded processor, or the like, or may be integrated in a system on a chip (SoC). Furthermore, according to some embodiments, processor 320 may be from the family of processors manufactured by Intel®, AMD®, Qualcomm®, Apple®, NVIDIA®, or the like. The processor 320 may also be based on the ARM architecture, a mobile processor, or a graphics processing unit, etc. The disclosed embodiments are not limited to any type of processor configured in server 310.

Memory 330 may include one or more storage devices configured to store instructions used by processor 320 to perform functions related to server 310. The disclosed embodiments are not limited to particular software programs or devices configured to perform dedicated tasks. For example, memory 330 may store a single program, such as a user-level application, that performs the functions associated with the disclosed embodiments, or may comprise multiple software programs. Additionally, processor 320 may, in some embodiments, execute one or more programs (or portions thereof) remotely located from server 310. Furthermore, memory 330 may include one or more storage devices configured to store data for use by the programs. Memory 330 may include, but is not limited to a hard drive, a solid-state drive, a CD-ROM drive, a peripheral storage device (e.g., an external hard drive, a USB drive, etc.), a network drive, a cloud storage device, or any other storage device.

In some embodiments, memory 330 may include a database 340. Database 340 may be included on a volatile or non-volatile, magnetic, semiconductor, tape, optical, removable, non-removable, or other type of storage device or tangible or non-transitory computer-readable medium (e.g., memory 330). Database 340 may also be part of server 310 or separate from server 310. When database 340 is not part of server 310, server 310 may exchange data with database 340 via a communication link. Database 340 may include one or more memory devices that store data and instructions used to perform one or more features of the disclosed embodiments. Database 340 may include any suitable databases, ranging from small databases hosted on a workstation to large databases distributed among data centers. Database 340 may also include any combination of one or more databases controlled by memory controller devices (e.g., server(s), etc.) or software. For example, database 340 may include document management systems, Microsoft SQL™ databases, SharePoint™ databases, Oracle™ databases, Sybase™ databases, other relational databases, or non-relational databases, such as mongo and others.

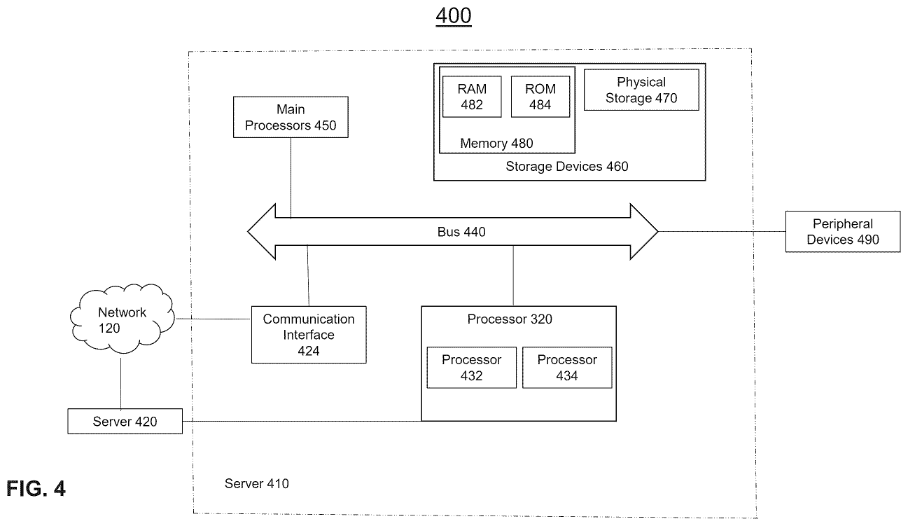

FIG. 4 is a schematic diagram of an exemplary distributed system 400 for implementing embodiments of the present disclosure. According to FIG. 4, server 410 (e.g., similar to server 310) of distributed computing system 400 includes a bus 440 or other communication mechanisms for communicating information, one or more processors 320 communicatively coupled with bus 440 for processing information, and one or more main processors 450 communicatively coupled with bus 440 for processing information. Processors 320 can be, for example, one or more microprocessors. In some embodiments, one or more processors 320 includes processor 432 and processor 434, and processor 432 and processor 434 are connected via an inter-chip interconnect of an interconnect topology. In some embodiments, processor 434 can be a dedicated hardware accelerator (such as a neural network processing unit) for processor 432. Main processors 450 can be, for example, central processing units (“CPUs”).

Server 410 may transmit data to or communicate with another server 420 through a network 120. Network 120 may be a local network, an internet service provider, Internet, or any combination thereof. Communication interface 424 of server 410 is connected to network 120, which may enable communication with server 420 (e.g., also similar to server 310). In addition, server 410 can be coupled via bus 440 to peripheral devices 490, which may include displays (e.g., cathode ray tube (CRT), liquid crystal display (LCD), touch screen, etc.) and input devices (e.g., keyboard, mouse, soft keypad, etc.).

Server 410 may be implemented using customized hard-wired logic, one or more ASICs or FPGAs, firmware, or program logic that in combination with the server functionality described herein causes server 410 to be a special-purpose machine.

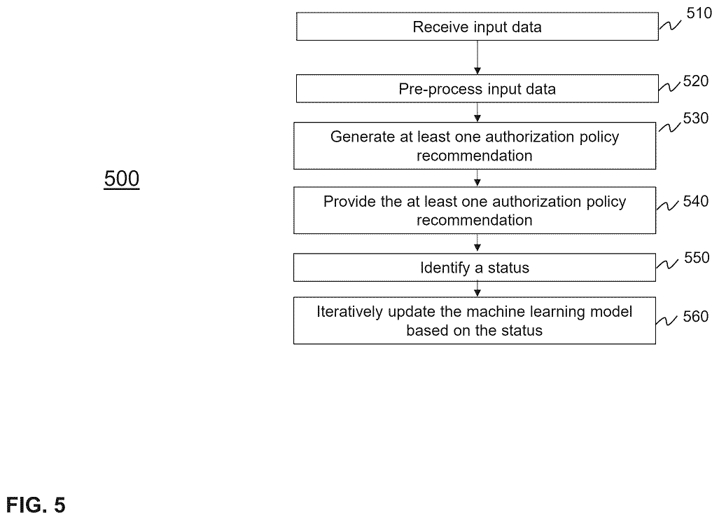

Server 410 further includes one or more storage devices 460, which may include memory 480 and physical storage 470 (e.g., hard drive, solid-state drive, etc.). Memory 480 may include random access memory (RAM) 482 and read-only memory (ROM) 484. Storage devices 460 may be communicatively coupled with processors 320 and main processors 450 via bus 440. Storage devices 460 may include a main memory, which can be used for storing temporary variables or other intermediate information during execution of instructions to be executed by processors 320 and main processors 450. Such instructions, e.g., those as discussed below in connection with FIG. 5, after being stored in non-transitory storage media accessible to processors 320 and main processors 450, render server 410 into a special-purpose machine that is customized to perform operations specified in the instructions. The term “non-transitory media” as used herein refers to any non-transitory media storing data or instructions that cause a machine to operate in a specific fashion (e.g., in accordance with FIG. 5, below). Such non-transitory media can include non-volatile media or volatile media. Non-transitory media include, for example, optical or magnetic disks, dynamic memory, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, flash memory, register, cache, any other memory chip or cartridge, and networked versions of the same.

Various forms of media can be involved in carrying one or more sequences of one or more instructions to processors 320 or main processors 450 for execution. For example, the instructions can initially be carried out on a magnetic disk or solid-state drive of a remote computer. The remote computer can load the instructions into its dynamic memory and send the instructions over a telephone line using a modem. A modem local to server 410 can receive the data and use an infra-red transmitter to convert the data to an infra-red signal. An infrared detector can receive the data carried in the infrared signal, and appropriate circuitry can place the data on bus 440. Bus 440 carries the data to the main memory within storage devices 460, from which processors 320 or main processors 450 retrieves and executes the instructions.

Recommendation system 200 (as shown in FIG. 2) or one or more of its components may reside on either server 310 or 410 and may be executed by processors 320 or 450.

FIG. 5 is a flowchart showing an example process for machine learning assisted authorization policy recommendations, consistent with disclosed embodiments. Process 500 may be performed by at least one processing device of a server (e.g., server 310 or 410), via a processor such as processor 320, as described above. In some embodiments, a non-transitory computer readable medium may contain instructions that when executed by a processor cause the processor to perform process 500. Further, process 500 is not necessarily limited to the steps shown in FIG. 5 and any steps or processes of the various embodiments described throughout the present disclosure may also be included in process 500.

In step 510, process 500 may include receiving input data for an organization. In some embodiments, input data may be received from an internal extract, transform, and load process. In some embodiments, input data may include application details, such as a file name, a publisher, a file path, and any other information related to the application.

In step 520, process 500 may include pre-processing the input data wherein the pre-processing may include a feedback loop to update the input data by providing feedback to the organization. In some embodiments, the pre-processing may include cleaning the input data using predetermined rules. In some embodiments, the pre-processing may include outlier detection of the input data. In some embodiments, input data may be provided to a profiling/personalization module to process and distribute data to a training model and inferences, as described with respect to FIG. 2.

In step 530, process 500 may include generating, using a machine learning model, at least one authorization policy recommendation based on the input data, wherein the machine learning model is trained using at least one of an organizational attribute, an organizational action, an organization policy, or domain information. In some embodiments, a behavioral profile for an organization is built, where the behavioral profile includes organizational specific information. In some embodiments, the profile includes industry security best practices for an organization and may include how best practices impact the organization. In some embodiments, how an organization reacts to and implements industry best practices may also be used to train the machine learning model. In some embodiments, another or a different machine learning model may be used. In some embodiments, the machine learning model may implement as least one of unsupervised learning, semi-supervised learning, active learning, or reinforcement learning techniques. In some embodiments, active learning may include an algorithm selecting a small number of sample data from the input data. The selected sample data may then be manually labeled by a user to improve the accuracy of the recommendation generated by process 500. In some embodiments, a label may refer to a functional role associated with an application. This information may then be used to target the recommendation. In some embodiments, the active learning model may take into account specific labels to provide better customization in recommendations. It is to be understood there may be no limit on the amount or kinds of machine learning models used. In some embodiments, the training or ranking may further comprise using at least one of a maturity level of the organization, best practices for an organization, or an organizational system configuration. In some embodiments, the machine learning model may use a ranking system. In some embodiments, the ranking system may receive input data associated with all organizations that are part of the system, rather than one individual organization. The ranking system may provide a score used as part of the training phase of the machine learning models to develop scores based on multiple organizations. In some embodiments, the machine learning model may implement at least one of semi-supervised learning, unsupervised learning, or reinforcement learning techniques.

In step 540, process 500 may provide the at least one authorization policy recommendation to the organization. In some embodiments, the at least one authorization policy recommendation may be automatically enforced by applying the at least one authorization policy recommendation to a network environment associated with the organization. In some embodiments, the at least one authorization policy recommendation may be automatically enforced if at least one predetermined condition is met. In some embodiments, the at least one authorization policy recommendation may be based on customization by the organization. In some embodiments, the authorization policy recommendation may include a confidence level. In some embodiments, the confidence level may comprise a categorical level and a probabilistic level. In some embodiments, the categorical level may be low, medium, or high. In some embodiments, the probabilistic level may be numerical.

In step 550, process 500 may identify a status of the at least one authorization policy recommendation, wherein the status comprises at least one organizational feedback. In some embodiments, organizational feedback may include whether an organization has chosen to accept, reject, edit, or ignore an authorization policy recommendation. In some embodiments, the identified status may further comprise calculation of an acceptance rate of the at least one authorization policy recommendation by the organization. In some embodiments, an organization may reject all recommendations. In other embodiments, an organization may accept all recommendations. In some embodiments, process 500 may monitor how an organization reacts to recommendations over time to create dynamic feedback that is then used to update the model, and therefore, update the recommendations generated by process 500. In some embodiments, the identifying may include accepting, ignoring, or rejecting the authorization policy recommendation using a user interface. In some embodiments, the identifying may include providing feedback based on the accepting, ignoring or rejection using the user interface. In some embodiments, the identifying may include using the feedback for the machine learning model. In some embodiments, the feedback may be used to mitigate against diversion from best practices. In some embodiments, the identifying may occur in real time. In some embodiments, the identifying may include reinforcing the authorization policy recommendation if the organization accepts the recommendation.

In step 560, process 500 may iteratively update the machine learning model based on the identified status.

FIG. 6 is an exemplary diagram of a user interface, consistent with disclosed embodiments. As shown in user interface 600, a user may view information related to certain policies. In some embodiments, a user may choose an action from a drop down menu to determine which policies to view. In some embodiments, a user may choose to elevate an action related to certain policies, such as allowing a policy recommendation or blocking a policy recommendation. In some embodiments, a user may also have the ability to create an advanced policy, edit a policy, or add information to a certain policy, consistent with disclosed embodiments.

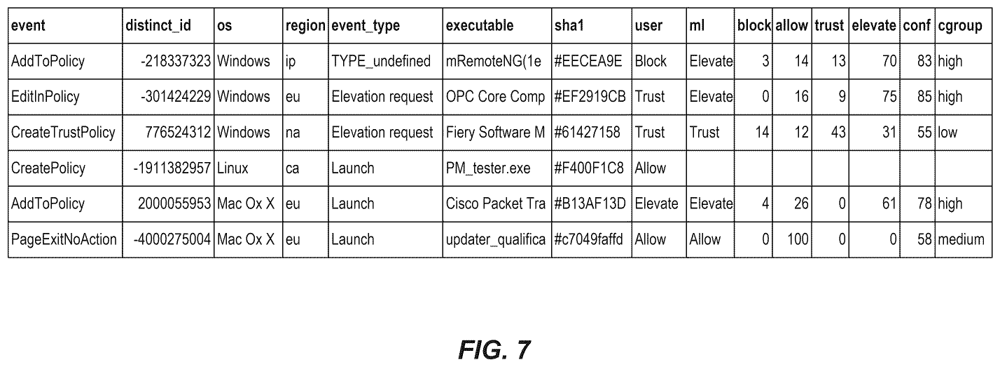

FIG. 7 is an exemplary diagram of a feedback loop, consistent with disclosed embodiments. In some embodiments, a comparison between the recommended action and the action an organization takes is used to provide feedback to the feedback loop, consistent with disclosed embodiments.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for developing machine-learning authorization policy recommendations, comprising:
receive input data for an organization;
pre-process the input data, wherein the pre-processing includes a feedback loop to update the input data by providing feedback to the organization;
generate, using a machine learning model, at least one authorization policy recommendation based on the input data, wherein the machine learning model is trained using at least one of: an organizational attribute, an organizational action, an organization policy, or domain information;
provide the at least one authorization policy recommendation to the organization;
identify a status of the at least one authorization policy recommendation, wherein the status comprises at least one organizational feedback; and
iteratively update the machine learning model based on the identified status.

2. The non-transitory computer-readable medium of claim 1, wherein the at least one authorization policy recommendation is automatically enforced by applying the at least one authorization policy recommendation to a network environment associated with the organization.

3. The non-transitory computer-readable medium of claim 1, wherein the at least one authorization policy recommendation is automatically enforced if at least one predetermined condition is met.

4. The non-transitory computer-readable medium of claim 1, wherein the identified status further comprises calculation of an acceptance rate of the at least one authorization policy recommendation by the organization.

5. The non-transitory computer-readable medium of claim 1, further comprising using at least one other machine learning model.

6. The non-transitory computer-readable medium of claim 1, wherein the machine learning model uses a ranking system for the training.

7. The non-transitory computer-readable medium of claim 6, wherein the ranking further comprises using at least one of a maturity level of the organization, best practices for an organization, or an organizational system configuration.

8. The non-transitory computer-readable medium of claim 1, wherein the machine learning model implements at least one of: unsupervised learning, semi-supervised learning, active learning, or reinforcement learning techniques.

9. The non-transitory computer-readable medium of claim 1, wherein the pre-processing further comprises cleaning the input data using predetermined rules.

10. The non-transitory-computer-readable medium of claim 1, wherein the pre-processing further comprises outlier detection of the input data.

11. The non-transitory computer-readable medium of claim 1, wherein the identifying comprises accepting, ignoring, or rejecting the at least one authorization policy recommendation via a user interface.

12. The non-transitory computer-readable medium of claim 11, wherein the identifying further comprises providing feedback based on the accepting, ignoring, or rejecting via the user interface.

13. The non-transitory computer-readable medium of claim 12, wherein the identifying further comprises using the feedback for the machine learning model.

14. The non-transitory computer-readable medium of claim 12, wherein the feedback is used to mitigate against diversion from best practices.

15. The non-transitory computer-readable medium of claim 1, wherein the identifying occurs in real-time.

16. The non-transitory computer-readable medium of claim 1, wherein the identifying further comprises reinforcing the at least one authorization policy recommendation if the organization accepts the recommendation.

17. The non-transitory computer-readable medium of claim 1, wherein the at least one authorization policy recommendation comprises a confidence level.

18. The non-transitory computer-readable medium of claim 17, wherein the confidence level comprises a categorical level and a probabilistic level.

19. A computer-implemented method for developing machine-learning authorization policy recommendations, the method comprising:
receiving, input data for an organization;
pre-processing the input data, wherein the pre-processing includes a feedback loop to update the input data by providing feedback to the organization;
generating, using a machine learning model, at least one authorization policy recommendation based on the input data, wherein the machine learning model is trained using at least one of: an organization attribute, an organization action, an organization policy, or domain information;
providing the at least one authorization policy recommendation to the organization;
identifying a status of the at least one authorization policy recommendation, wherein the status comprises at least one organizational feedback;
iteratively updating the machine learning model based on the identified status on a predetermined basis; and
providing an updated at least one authorization policy to a user interface based on the iterative update.
